(19) United States
(12) Patent Application Publication
(10) Pub. No.: US 2015/0357664 A1
(43) Pub. Date: Dec. 10, 2015

(54) Plate type fuel reformer of fuel cell

(71) Applicants: Szu-Han Wu, Taoyuan County (TW); Shih-Wei Cheng, Taoyuan County (TW); Hung-Hsiang Lin, Taoyuan County (TW); Yung-Neng Cheng, Taoyuan County (TW); Ruey-yi Lee, Taoyuan County (TW)

(72) Inventors: Szu-Han Wu, Taoyuan County (TW); Shih-Wei Cheng, Taoyuan County (TW); Hung-Hsiang Lin, Taoyuan County (TW); Yung-Neng Cheng, Taoyuan County (TW); Ruey-yi Lee, Taoyuan County (TW)

(21) Appl. No.: 14/297,604

(22) Filed: Jun. 5, 2014

(51) Int. Cl. H01M 8/06

(52) U.S. Cl. CPC H01M 8/0618

(57) ABSTRACT

A plate type fuel reformer of fuel cells includes a reformer module stacked by multiple sheet components, and an engaging surface formed on a surface of the reformer module and adhered to a surface of the default fuel cell module in order to form a great thermally-conductive combination. Detachable connections are formed between each of the sheet components and between the sheet components and the fuel cells module. The edge of the reformer module is non-protruding from the side of the fuel cell module after connection. Multiple containing spaces are respectively formed between each of the sheet components for containing default catalyst units. Also, an independent air channel is formed for guiding outside air to into the fuel cell module and a fuel channel is formed for containing the default catalyst units and guiding outside fuel to react with the catalyst units to generate hydrogen gas and carbon monoxide.

### BACKGROUND OF THE INVENTION

1. Field of the Invention

The present invention relates to a plate type fuel reformer of a fuel cell, in particular to the reformer modulated and combined with a fuel cell, thereby providing a reformer structure with better heat transfer efficiency, ease of detachment and assembly and wide scope of applications.

2. Description of the Related Art

Conventional fuel cells can be divided to high temperature type fuel cells and low temperature type fuel cells based on their working temperature. The high temperature type fuel cells provide more efficiency due to its advantages of introducing fuel gas, such as methane, to the anode directly without using a noble metal catalyst.

Methane is the main component of natural gas that is reserved richly in nature, as well as an alternative fuel to replace traditional energy sources. Methane has already been adopted as an ideal fuel in the commercialization process of fuel cells, but mainly to generate hydrogen by external reforming to supply to fuel cells. There are many shortcomings of external reforming, for example, the oversized volume of external reformers cannot be integrally designed with system components, the time of heat transfer is too long and unevenly distributed, and the equipments used in reforming and transferring process in the industry are of large scale, for example, for byproducts of petroleum cracking.

A complete fuel cell comprises: a fuel treatment part, a fuel cell, a DC-AC converter and a thermal management part. The fuel treatment part plays an important role in whole system, thus the fuel treatment part has to be overall considered about the efficiency of system and the process of thermal energy optimization. At first, the fuel of the fuel cell uses recombinant product of hydrocarbon fuels. A solid oxide fuel cell (SOFC) is exemplified in the following description about the circulation process of fuel cells. First, the fuel passes through an external reformer containing hydrocarbon conversion catalyst monomer to generate hydrogen-rich gas. Then the hydrogen-rich gas is entered into the anode of the fuel cell. The main ingredients of the mixed gas, H₂ [symbol] CO, carry out electrochemical oxidation with O²⁻ ion and release electrons to the cathode along the outer circuit. The oxygen is adsorbed on the surface of the cathode, and gets electrons to dissociate to O²⁻ ions. The O²⁻ ions is permeated into the reaction zone at the interface of the anode and the electrolyte, and an electrochemical reaction is carried out here.

TW Patent No. 282872 discloses an improved structure of a methane reformer for fuel cells. The improved structure comprises multiple heat insulation walls, thereby forming a first space, a second space, a third space and a forth space. The first space, the second space and the third space are interconnected, but the forth space and the third space are not connected in order to block the connection of the heating gas and the cooling gas. A first catalyst bed is set in the second space. A preheated flexible tube is coiled in the first space and the third space, and interconnected to the first catalyst bed. A carbon monoxide conversion catalyst bed is set in the forth space and interconnected to the first catalyst bed, and further comprises a second catalyst bed, a high temperature carbon monoxide catalyst bed and a low temperature carbon monoxide catalyst bed. The second catalyst bed makes the reaction fluid which is not reacted completely in the first catalyst bed react more completely. The carbon monoxide is transformed to carbon dioxide along the high temperature catalyst and the low temperature catalyst, thereby providing just hydrogen and carbon dioxide to the fuel cell. Such design can simplify the exterior design. The problems include complicated internal structure, irreplaceable components and the amount of treated fuel is determined by the volume of the internal catalyst.

U.S. Pat. No. 7,976,592 discloses a plate type reformer and fuel cell system including the reformer, wherein the reformer is composed of multiple reforming reaction plates and compacted by welded edges. The conventional reformer lacks convenience of dismantlement or construction for maintenance of the reformer.

### SUMMARY OF THE INVENTION

The first objective of the present invention is to provide a plate type fuel reformer of a fuel cell with the same volume as the fuel cell, such that the whole set of the fuel cell components can be regarded as a module, which can be replaced immediately while any requirement or problems occur in practical application, and provide convenience and diversity of the use.

The second objective of the present invention is to provide a plate type fuel reformer of a fuel cell. The plate type fuel reformer and the fuel cell are formed as a detachable sealing structure, which is different from the traditional manner of welding connection that requires external forces to disassemble. As such, the reformer of the present invention provides convenience of operation.

The third objective of the present invention is to provide a plate type fuel reformer of a fuel cell. The plate type reformer and the fuel cell are contacted mutually. Thus, the heat generated from the fuel cell can be transferred and quickly given to the reformer for utilization to prevent heat loss, and get more efficiency of heat transfer.

The fourth objective of the present invention is to provide a plate type fuel reformer of a fuel cell. The plate type reformer and the fuel cell is contacted mutually, such that the reformer with functions of preheat gasification and steam reforming can be suitable for structural design with small volume and high power, as well as being widely used as stationary fuel cell and hydrogen production on car.

To achieve the foregoing objectives, the present invention provides a plate type fuel reformer of a fuel cell, which comprises:

a reformer module stacked by multiple sheet components, and detachably connected to a fuel cell module, wherein the edge of the reformer module is non-protruding from the edge of the fuel cell module;

an engaging surface formed on a surface of the reformer module and corresponded to a surface of the default fuel cell module;

multiple containing spaces respectively formed between each of the sheet components for containing default catalyst unit;

an independent air channel formed on the sheet components and used for guiding outside air into the fuel cell module; and

a fuel channel formed on the sheet components, capable of passing through each of the containing spaces, and used for guiding outside fuel to react with the catalyst units to generate hydrogen gas and carbon monoxide, whereby the hydrogen gas and the carbon monoxide flow into the fuel cell module and electrochemically react with the air.

Based on the above structure, the reformer module further comprises:

at least one base member with thermal conductivity, having:

a first space formed on a top surface of the base member, a first fuel inlet mounted at one side of the first space and capable of passing through a bottom surface of the base member, and a first air outlet mounted at one side of the first fuel inlet that separated from the first space and capable of passing through the bottom surface of the base member;

at least one spacing member with thermal conductivity sandwiched installed at one side of an opening of the first space of the base member and having the same shape as that of the base member, having:
a second space formed on a top surface of the spacing member, a second fuel inlet mounted at one side far away from the first fuel inlet in the second space and capable of passing through the spacing member, a second air outlet mounted at one side of the fuel second inlet that separated from the second space of the spacing member and capable of passing through a bottom surface of the spacing member, a second fuel outlet and an second air inlet mounted at one side of the spacing member close to the second fuel inlet that separated from the second space of the spacing member and capable of passing through the bottom surface of the spacing member; and

a covering member with thermal conductivity sandwiched installed at one side of an opening of the second space of the spacing member and having the same shape as that of the base member, having:
an engaging surface formed at one side far away from the spacing member and corresponded to a surface of the default fuel cell, a third fuel outlet formed at one edge of the engaging surface, capable of passing through the covering member and corresponded to the second fuel outlet, an third air inlet formed at one edge of the engaging surface, capable of passing through the covering member and corresponded to the second air inlet, and an third air outlet and a third fuel inlet formed at one edge of the engaging surface and capable of passing through the covering member and corresponded to the second air outlet and the second fuel inlet respectively,
wherein the fuel flow channel is formed by connection of the first fuel inlet, the first fuel outlet, the second fuel inlet, the second fuel outlet, the third fuel inlet and the third fuel outlet, and the air channel formed by connection of the first air inlet, the first air outlet, the second air inlet, the second air outlet, the third air inlet and the third air outlet.

Based on the above structure, the peripheries of the base member, the spacing member and the covering member are adhered together by heat-resistant glass clue, then sealed and fixed separately from outside, and the base member, the spacing member and the covering member are connected detachably due to the heat-resistant glass clue easy to be destroyed by external forces.

Based on the above structure, multiple first connecting holes are formed on the base member, the spacing member and the covering member, whereby multiple fasteners mounted through the first connecting holes and the base member, the spacing member and the covering member are connected together.

Based on the above structure, the fuel cell module has multiple second connecting hole formed on the peripheral edge of the fuel cell module, and the second connecting holes of the fuel cell module is corresponded to the first connecting holes of the reformer module.

Based on the above structure, the base member has a first collecting part formed in the first space and corresponded to the second fuel inlet, the collecting part is recessed outwardly and obliquely; the spacing member has a second collecting part formed in the second space and corresponded to the first fuel inlet, and the second collecting part of the spacing member is recessed outwardly and obliquely.

Based on the above structure, the catalyst units are made of Pt/CeO₂-α-Al₂O₃.

### BRIEF DESCRIPTION OF THE DRAWINGS

FIG. 1 is an exploded view of an embodiment of the reformer of the present invention;

FIG. 2 is a schematic view of the direction of flow path of fuel and air in a reformer of the present invention;

FIG. 3 is a perspective view of an embodiment of the reformer of the present invention; and

FIG. 4 is an exploded view of a fuel cell and a reformer of the present invention.

### DETAILED DESCRIPTION OF THE PREFERRED EMBODIMENTS

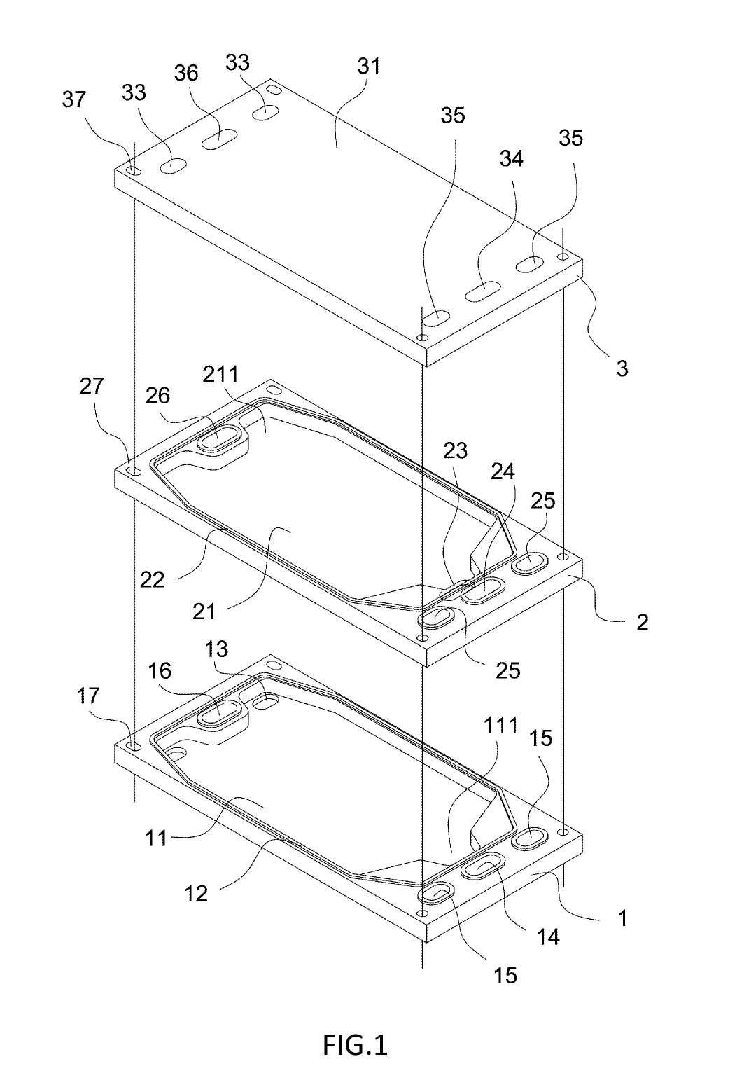

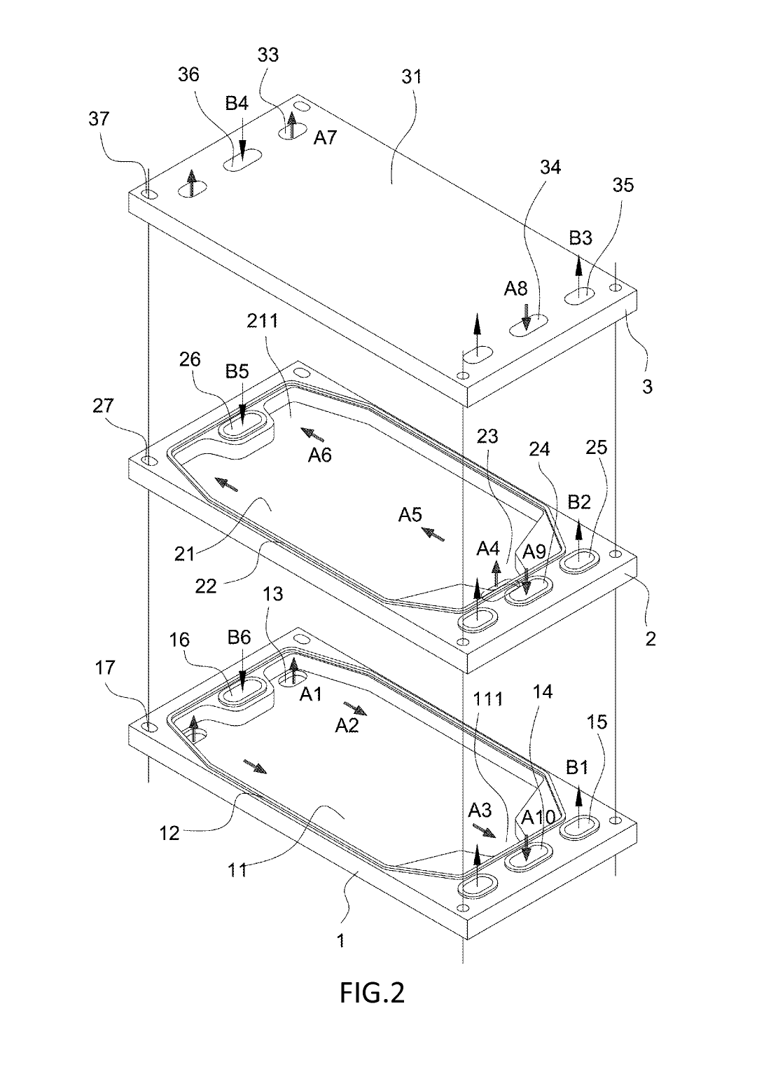

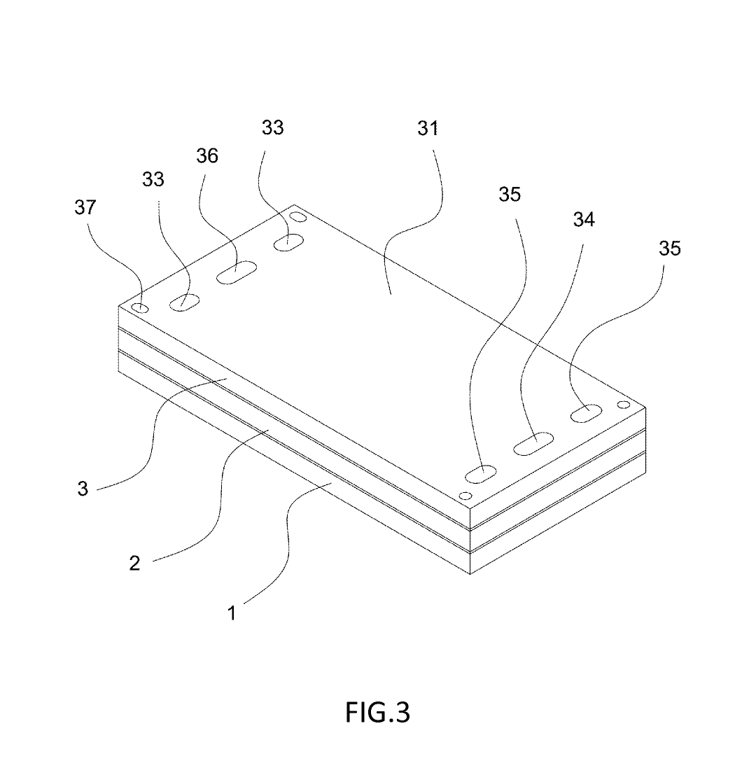

With referred to FIG. 1 to FIG. 3, an embodiment of a reformer of the present invention mainly comprises a base member 1, a spacing member 2, and a covering member 3. The base member 1 is a plate shaped structure with capable of thermal conduction. A first space is formed on a top surface thereof. A first collecting part 111 is formed in one side of the first space 11 and recessed outwardly and obliquely. A first fuel inlet 13 is formed at the other side of the first space 11, and passed through a bottom surface of the base member 1. A first surrounding flange 12 is formed around the first space 11 and protruding from the first space 11. A first air outlet 16 is formed in the first surrounding flange 12 close to a side of the first fuel inlet 13 that separated from the first space 11, and perforating the bottom surface of the base member 1. A first fuel outlet 14 and a first air inlet 15 are formed in the outer of the first surrounding flange 12 close to a side of the first collecting part 111 that separated from the first space 11, and perforating the bottom surface of the base member 1. Multiple first connecting holes 17 are formed around the base member 1, and perforating the base member 1 downwardly.

The spacing member 2 is a plate shaped structure with capable of thermal conduction, and the shaped of the spacing member 2 is same as the base member 1, such that the peripheries of the spacing member 2 and the base member 1 are same shaped when the spacing member 2 and the base member 1 are folded up mutually. The spacing member 2 has a second space 21, a second fuel inlet 23, a second collecting part 211, a second surrounding flange 22, a second air outlet 26, a second fuel outlet 24, a second air inlet 25, and multiple second connecting holes 27. The second space 21 is formed on a top surface of the spacing member 2. The second fuel inlet 23 is mounted at one side of the second space 21, capable of passing through the spacing member 2, and corresponding to the first collecting part 111. The second collecting part 211 is formed in the other side of the second space 21, recessed outwardly and obliquely, and corresponding to the first fuel inlet 13. The second surrounding flange 22 is formed around the second space 21. The second air outlet 26 is mounted in the second surrounding flange 26 close to the second collecting part 211 that separated from the second space 21, and perforating a bottom surface of the spacing member 211. The second fuel outlet 24 is mounted in the outer of the second surrounding flange 22 close to one side of the second fuel inlet 23 that separated from the second space 21, perforating the bottom surface of the spacing member 2, and corresponding to the first fuel outlet 14. The second air inlet 25 is mounted in the outer of the second surrounding flange 22 close to one side of the second fuel inlet 23 that separated from the second space 21, perforating the bottom surface of the spacing member 2, and corresponding to the first are inlet 15. The second connecting holes 27 is formed around the spacing member 2, perforating the spacing member 2 downwardly, and corresponding to the first connection holes 17.

The covering member 3 is a plate shaped structure with capability of thermal conduction, and the shaped of the covering member 3 is same as the base member 1, such that the peripheries of the covering member 3, spacing member 2 and base member 1 are same shaped when the covering member 3, spacing member 2 and base member 1 are folded up mutually. The covering member 3 comprises an engaging surface 31, a third fuel outlet 34, a third air inlet 35, a third fuel inlet 33, a third air outlet 36 and multiple third connecting holes 31. The engaging surface 31 is formed at one side of the covering member 3. The third fuel outlet 34 is formed at one side edge of the engaging surface 31, perforating the covering member 3, and corresponding to the second fuel outlet 24. The third air inlet 35 is formed at one side edge of the engaging surface 31, perforating the covering member 3, and corresponding to the second air inlet 25. The third fuel inlet 33 is formed at the other one side edge of the engaging surface 31, perforating the covering member 3, and corresponding to the second collecting part 211. The third air outlet 36 is formed at the other one side edge of the engaging surface 31, perforating the covering member 3, and corresponding to the second air outlet 26. The multiple third connecting holes 31 are formed around the covering member 3, perforating the covering member 3 downwardly, and corresponding to the second connecting holes 27.

In an embodiment of the present invention, the first space 11 and the second space 21 respectively contains a catalyst monomer (not shown in figures; the shapes, materials and principles of working can be referred to TW Patent No. M281305, and an example using Pt/CeO₂-α-Al₂O₃ as material describes below). The peripheries of the base member 1, the spacing member 2 and the covering member 3 are adhered together by heat-resistant glass clue then sealed from outside, such that the first space is connected to outside by the first fuel inlet 13. The second space 21 is connected to outside by the third fuel inlet 33. The first space 11 and the second space 21 are connected by the second fuel inlet 23, and the fuel inlets and the fuel outlets are formed into a channel for fuel.

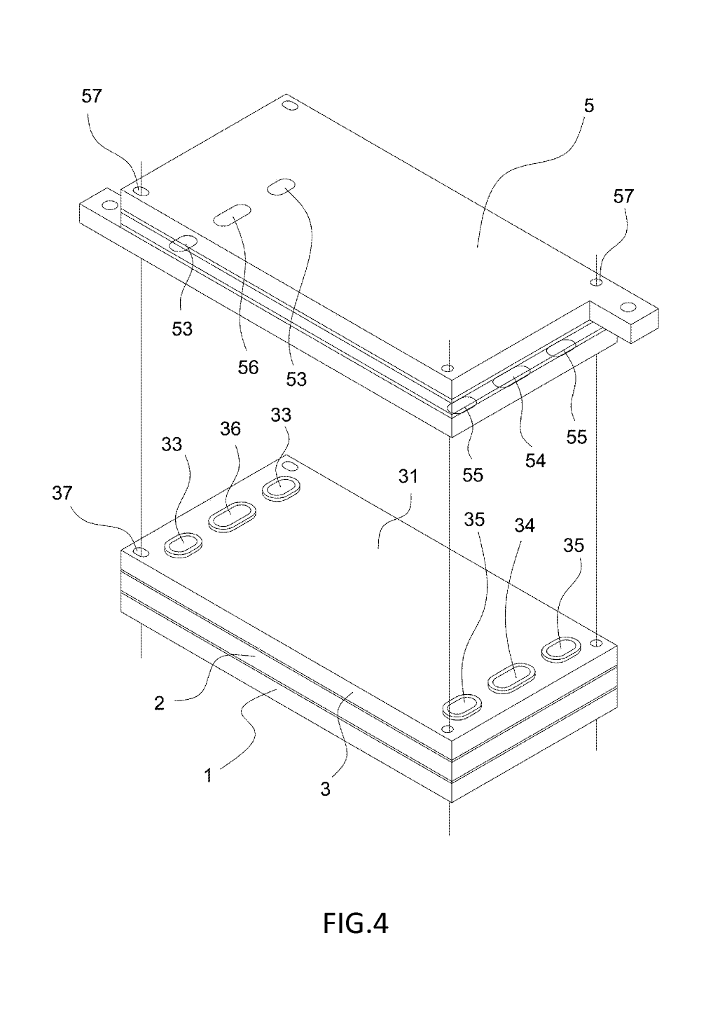

Air can be introduced from the first air inlet 15, then through the second air inlet 25, the third air inlet 35 (as shown as the arrows of B1, B2 and B3) and the inside of the subsequent fuel cell module 5 (shown in FIG. 4). The air flowed from the fuel cell module 5 can be introduced into the third air outlet 36, then outwardly along the second air outlet 26 and the first air outlet 16 (shown as the arrows of B4, B5 and B6), such that a complete channel of air is formed.

With reference to FIG. 4, the engaging surface 31 of the reformer module combined by the base member 1, the spacing member 2 and the covering member 3 is contacted directly to a surface of a fuel cell module 5 (cell stack). The fuel cell module 5 comprises a fuel guiding outlet 54, a fuel guiding inlet 53, an air guiding inlet 55, an air guiding outlet 56 and multiple connecting holes 57. The fuel guiding outlet 54 is formed at one side of the fuel cell close to the engaging surface 31 and corresponding to the third fuel outlet 34. The fuel guiding inlet 53 is formed at one side of the fuel cell close to the engaging surface 31, and corresponding to the third fuel inlet 33. The air guiding inlet 55 is formed at one side of the fuel cell close to the engaging surface 31, and corresponding to the third air inlet 35. The air guiding outlet 56 is formed at one side of the fuel cell close to the engaging surface 31, and corresponding to the third air outlet 36. The multiple connecting holes 57 are formed around the fuel cell module 5, and corresponding to the third connecting holes 37. Multiple fasteners (not shown) perforate the connecting holes 57 and the first connecting holes 17 respectively, such that the reformer module and the fuel cell module 5 are combined.

The hydrogen and carbon monoxide generated from the reaction of the above-mentioned fuel (methane) and each catalyst monomers can be introduced from the third fuel inlet 33 along the fuel guiding inlet 53 into the fuel cell module 5, and the outside air can pass through the first air inlet 15, the second air inlet 25, the third air inlet 35 and the air guiding inlet 55 then into the fuel cell module 5 along the default manifold, whereby the air and the above-mentioned hydrogen and carbon monoxide carry out electrochemical reactions. Then, extra air is capable of flowing outwardly from the air guiding outlet 56 and then through the third air outlet 36, the second air outlet 26 and the first air outlet 16. The extra hydrogen and carbon monoxide is capable of flowing outwardly from the fuel guiding outlet 54 along the third fuel outlet 34, the second fuel outlet 24 and the first fuel outlet 14, such that a required circulation is formed.

In the above combined structure, the reformer module provides effects of heat conduction by making the engaging surface 31 contacted directly to the fuel cell 5, or provide effects of heat radiation using the heat generated from the fuel cell module 5, such that the reformer module is heated by the air with lots of heat generated from the fuel cell module 5. Therefore, the reformer module has better efficiency of heat transfer. In an embodiment of the present invention, 40 g catalyst and 0.351 pm fuel can produce methane with 1.51 pm of air (H₂+CO) under the conditions of reaction temperature at or higher than 800° C. and S/C ratio of 2.0, and the conversion rate of methane maintains over 98 percent after tested for 550 hours.

The fuel cell module 5 (cell stack) and the plate type reformer module are formed into a detachable structure and adhered together by heat-resistant glass clue. Such structure is different from traditional types which are combined by welding that requires external force to detach. The easily detached and operated structural combination can be increased or decreased numbers of the base member 1 and the spacing member 2 depending on the wattage of the fuel cell modules 5, such that the spaces 11, 21 having different volumes and sizes is able to contain different catalyst monomer and thus achieves desired effect of changing amount of treated fuel.

Briefly, the plate type fuel reformer of fuel cells is ensured to achieve improved efficiency of heat transfer, easiness of attachment and detachment and wide range of utilization, and thus the novelty and nonobviousness of the present should be concerned. Even though numerous characteristics and advantages of the present invention have been set forth in the foregoing description, the disclosure is illustrative only, not to limit the invention. Changes may be made in the details, and arrangement of parts within the principles of the invention to the full extent indicated by the broad general meaning of the terms in which the appended claims are expressed.

What is claimed is:

1. A plate type fuel reformer of fuel cell, comprising:
a reformer module stacked by multiple sheet components and detachably connected to a fuel cell module, wherein the edge of the reformer module is an engaging surface formed on a surface of the reformer module and corresponded to a surface of the default fuel cell module;
multiple containing spaces respectively formed between each of the sheet components for containing default catalyst unit;
an independent air channel formed on the sheet components and used for guiding outside air into the fuel cell module;
multiple containing spaces respectively formed between each of the sheet components for containing default catalyst units;
an independent air channel formed on the sheet components for guiding outside air into the fuel cell module; and
a fuel channel formed on the sheet components, capable of passing through each of the containing spaces, and used for guiding outside fuel to react with the catalyst units to generate hydrogen gas and carbon monoxide, whereby the hydrogen gas and the carbon monoxide flow into the fuel cell module and electrochemically react with the air.

2. The plate type fuel reformer of fuel cells as claimed in claim 1, further comprising:
at least one base member with thermal conductivity, comprising a first space formed on a top surface of the base member, a first fuel inlet mounted at one side of the first space and capable of passing through a bottom surface of the base member, a first air outlet mounted at one side of the first fuel inlet that separated from the first space and capable of passing through the bottom surface of the base member, and a first fuel outlet and a first air inlet mounted at the outside of the other side of the first fuel inlet that separated from the first space and capable of passing through the bottom surface of the base member;
at least one spacing member with thermal conductivity sandwiched installed at one side of an opening of the first space of the base member and having the same shape as that of the base member, comprising a second space formed on a top surface of the spacing member, a second fuel inlet mounted at one side far away from the first fuel inlet in the second space and capable of passing through the spacing member, a second air outlet mounted at one side of the fuel second inlet that separated from the second space of the spacing member and capable of passing through a bottom surface of the spacing member, a second fuel outlet and an second air inlet mounted at one side of the spacing member close to the second fuel inlet that separated from the second space of the spacing member and capable of passing through the bottom surface of the spacing member; and
a covering member with thermal conductivity sandwiched installed at one side of an opening of the second space of the spacing member and having the same shape as that of the base member, and comprising an engaging surface formed at one side far away from the spacing member and corresponded to a surface of the default fuel cell, a third fuel outlet formed at one edge of the engaging surface, capable of passing through the covering member and corresponded to the second fuel outlet, an third air inlet formed at one edge of the engaging surface, capable of passing through the covering member and corresponded to the second air inlet, an third air outlet and a third fuel inlet formed at one edge of the engaging surface and capable of passing through the covering member and corresponded to the second air outlet and the second fuel inlet respectively;
wherein the fuel flow channel is formed by connection of the first fuel inlet, the first fuel outlet, the second fuel inlet, the second fuel outlet, the third fuel inlet and the third fuel outlet, and the air channel formed by connection of the first air inlet, the first air outlet, the second air inlet, the second air outlet, the third air inlet and the third air outlet.

3. The plate type fuel reformer of fuel cells as claimed in claim 2, wherein the peripheries of the base member, the spacing member and the covering member are adhered together by heat-resistant glass clue then sealed and fixed separately from outside, and due to the heat-resistant glass clue easy to destroyed by external forces, the base member, the spacing member and the covering member are connected detachably.

4. The plate type fuel reformer of fuel cells as claimed in claim 3, wherein multiple first connecting holes are formed on the base member, the spacing member and the covering member, whereby multiple fasteners mounted through the first connecting holes and the base member, the spacing member and the covering member are connected together.

5. The plate type fuel reformer of fuel cells as claimed in claim 4, wherein the fuel cell module has multiple second connecting hole formed on the peripheral edge of the fuel cell module, and the second connecting holes of the fuel cell module is corresponded to the first connecting holes of the reformer module.

6. The plate type fuel reformer of fuel cells as claimed in claim 2, wherein the base member has a first collecting part formed in the first space and corresponding to the second fuel inlet, the first collecting part is recessed outwardly and obliquely, the spacing member has a second collecting part formed in the second space and corresponded to the first fuel inlet, and the second collecting part of the spacing member is recessed outwardly and obliquely.

7. The plate type fuel reformer of fuel cells as claimed in claim 1, wherein the catalyst units are made of Pt/CeO₂-α-Al₂O₃.
